(19) United States
(12) Patent Application Publication
(10) Pub. No.: US 2025/0279516 A1
(43) Pub. Date: Sep. 4, 2025

(54) ELECTROCHEMICAL APPARATUS, ELECTRONIC DEVICE, AND MANUFACTURING METHOD FOR ELECTROCHEMICAL APPARATUS

(71) Applicant: Ningde Amperex Technology Limited, Ningde (CN)

(72) Inventor: Luocheng LIU, Ningde (CN)

(73) Assignee: Ningde Amperex Technology Limited, Ningde (CN)

(21) Appl. No.: 19/210,182

(22) Filed: May 16, 2025

Related U.S. Application Data
(63) Continuation of application No. PCT/CN2022/132454, filed on Nov. 17, 2022.

(51) Int. Cl. H01M 50/186; H01M 50/105; H01M 50/14; H01M 50/178; H01M 50/184; H01M 50/519; H01M 50/536; H01M 50/553

(52) U.S. Cl. CPC H01M 50/186; H01M 50/105; H01M 50/14; H01M 50/178; H01M 50/184; H01M 50/519; H01M 50/536; H01M 50/553

(57) ABSTRACT

The electrochemical apparatus includes a battery cell, a packaging bag, and a sealing piece. The battery cell is disposed in the packaging bag, and a tab of the battery cell protrudes from a sealing edge of the packaging bag. The sealing piece is disposed on both side of the tab, a top edge of the sealing piece is located outside the packaging bag, and a bottom edge is located inside the packaging bag. The top edge includes a first section, and a second section and a third section located at two ends of the first section. A length of the first section is A, a length of the bottom edge is B, and a width of the tab is C, meeting B>A≥C. A height of the second section or the third section is H, meeting 0.05 mm≤H≤0.5 mm.

### CROSS-REFERENCE TO RELATED APPLICATIONS

This application is a continuation of International Application No. PCT/CN2022/132454, filed on Nov. 17, 2022, the contents of which are incorporated herein by reference in its entirety.

### TECHNICAL FIELD

This application relates to the field of battery technology, and in particular, to an electrochemical apparatus, an electronic device, and a manufacturing method.

### BACKGROUND

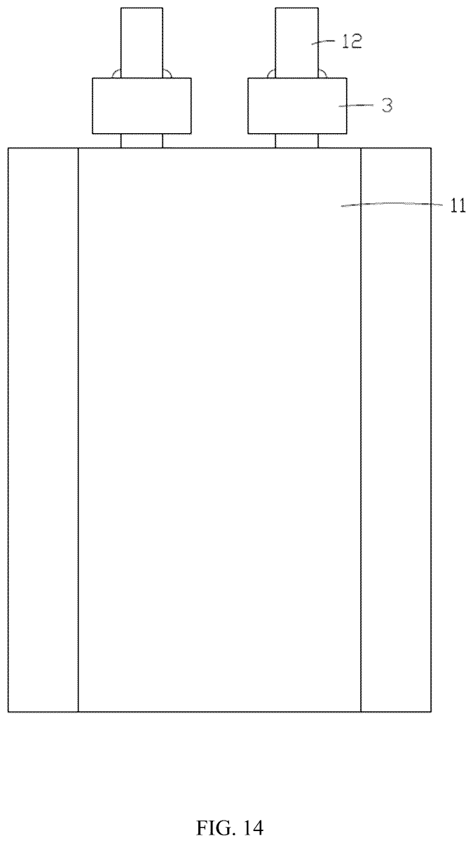

As shown in FIGS. 14 to 16, in the electrochemical apparatus of the prior art, the sealing piece is a conventional rectangle to ensure effective sealing between a tab and a packaging bag. However, during the hot pressing and sealing process of the conventional rectangular sealing piece, due to the double effects of high temperature softening and compression, part of the sealing piece exposed by the packaging bag tends to deform outward, causing two sides of a top end of the sealing piece to warp up, thus increasing the exposed length of the sealing piece. After the tab is bent, the warping part of the top end of the sealing piece causes the electrochemical apparatus to be subjected to interference between a battery and a battery compartment during the assembly of an electronic device. Alternatively, to prevent the warping part from being exposed, the bending position of the tab needs to be set back, increasing the overall length of the electrochemical apparatus and affecting the energy density. Additionally, the warping on two sides of the top end of the sealing piece is also likely to cause the sealing piece to protrude relative to the battery in the thickness direction of the battery, affecting the energy density.

### SUMMARY

This application provides an electrochemical apparatus, an electronic device, and a manufacturing method to resolve the above technical problems.

An embodiment of this application provides an electrochemical apparatus, including a battery cell, a packaging bag, and a sealing piece. The battery cell includes an electrode plate and a tab connected to the electrode plate. The battery cell is disposed in the packaging bag, and the tab protrudes from a sealing edge of the packaging bag. The sealing piece is disposed on both side of the tab, and the packaging bag covers part of the sealing piece. The sealing piece includes a top edge and a bottom edge opposite each other, the top edge is located outside the packaging bag, and the bottom edge is located inside the packaging bag. The top edge includes a first section, a second section, and a third section, the second section and the third section are respectively located on two sides of the first section, and along a width direction of the tab, a length of the first section is A, a length of the bottom edge is B, and a width of the tab is C, meeting B>A≥C. Along an extension direction of the tab, a distance from any point on the second section and the third section to the bottom edge is less than a distance between the first section and the bottom edge. Along the extension direction of the tab, a distance between two ends of the second section or the third section is a height H of the second section or the third section, where 0.05 mm≤H≤0.5 mm.

Thus, along the extension direction of the tab, the second section and the third section do not exceed the first section. The height difference between the second section and the first section and the height difference between the third section and the first section can reduce the impact caused by the outward-extending deformation of the top edge. By limiting the ranges of the height difference between the second section and the first section and the height difference between the third section and the first section, the problem of the sealing piece warping in the thickness direction of the battery cell can be alleviated, thereby lowering the probability of two sides of the top end of the sealing piece extending outward and warping. This helps reduce the length and thickness of the electrochemical apparatus, thereby increasing the energy density. Additionally, by limiting the height ranges of the second section and the third section, the risk of electrolyte leakage caused by the second section and the third section entering the packaging bag can be reduced, thereby increasing the energy density of the electrochemical apparatus in a case of small electrolyte leakage rate losses of the electrochemical apparatus and alleviating the interference problem during assembly.

In a possible embodiment, 0 mm≤B−A≤8 mm. Through this arrangement, the length A of the first section is less than the length B of the bottom edge, and the second section and the third section can be formed on two sides of the first section. If the width of the bottom edge is constant, when the value of B−A is too large, the difference between the length of the first section and the width of the tab is too small, which is likely to cause cracking at the joint between the sealing piece and the tab during assembly, form a leakage channel, and increase the electrolyte leakage rate of the electrochemical apparatus.

In a possible embodiment, 1.8 mm≤B−A≤8 mm. Through this arrangement, the two ends of the first section can form distinct second section and third section, reducing the exposed size and warping amount of the sealing piece, alleviating interference problems during assembly, and reducing the loss of energy density of the electrochemical apparatus, while not causing a high electrolyte leakage rate of the electrochemical apparatus.

In a possible embodiment, 3 mm≤B−A≤7 mm. This arrangement helps further reduce the exposed size of the sealing piece without significantly damaging the sealing performance of the electrochemical apparatus.

In a possible embodiment, 0.15 mm≤H≤0.3 mm. This parameter range is also the height parameter range of the second section and/or the third section of the sealing piece after hot melting. This can further reduce the exposed size of the sealing piece, improve the energy density performance, alleviate leakage problems of the electrochemical apparatus, and meet subsequent assembly requirements.

In a possible embodiment, a distance from an end of the second section or the third section connected to the first section to the tab is W, where 0.3 mm≤W≤1.1 mm. This parameter range is also the parameter range of the shoulder width of the top edge of the sealing piece after hot melting of the sealing piece, which helps maintain the covering effect of the sealing piece on the tab and ensures the sealing performance between the tab and the packaging bag.

In a possible embodiment, a distance between a side edge of the sealing piece and a corresponding side edge of the tab is X, where 1.5 mm≤X≤4.5 mm. Through such arrangement, an end of the bottom edge of the sealing piece exceeds an end of the first section, increasing the contact area of the sealing piece in the packaging bag, which helps ensure the sealing effect between the tab and the packaging bag.

In a possible embodiment, along the extension direction of the tab, a distance between the first section and the bottom edge is a height Y of the sealing piece, where 3.5 mm≤Y≤12.5 mm. A suitable value may be chosen based on the size of the tab to maintain the sealing effect between the tab and the packaging bag while reasonably planning the height dimensions of the sealing piece, alleviating the problem of the increase in the overall size of the electrochemical apparatus caused by excessive exposure of the sealing piece.

In a possible embodiment, the second section is obliquely connected between an end of the first section and a side edge of the sealing piece, and the third section is obliquely connected between another end of the first section and another side edge of the sealing piece. Thus, the second section and the third section form chamfered structures on two sides of the top edge of the sealing piece, and these simple structures can reduce the impact caused by the outward-extending deformation of the sealing piece.

In a possible embodiment, the second section is an arc section connected between an end of the first section and a side edge of the sealing piece, and the second section is recessed toward a side edge of the tab or the second section is bent toward an outer side of the sealing piece.

In a possible embodiment, the third section is an arc section connected between another end of the first section and another side edge of the sealing piece, and the third section is recessed toward the side edge of the tab or the third section protrudes toward the outer side of the sealing piece.

Thus, the end of the top edge of the sealing piece forms a rounded corner structure, and the second section and the third section do not exceed the first section along the extension direction of the tab. The rounded corner structure can reduce sharp parts at the end of the sealing piece, effectively reducing the warping of the sealing piece.

In a possible embodiment, the second section and/or the third section is provided with a depression, such that the second section and/or the third section includes a first subsection and a second subsection. The first subsection is located between the first section and the second subsection, the second subsection includes at least one section, an endpoint connecting the first subsection and the first section is M, an endpoint connecting the second subsection and the side edge of the sealing piece is N, the connection endpoint M and the connection endpoint N form a line segment MN, and an included angle between the first section and the line segment MN is greater than 90°. The included angle between the first section and the line segment MN being less than 90° causes the second section to warp. Setting the included angle between the first section and the line segment MN to be greater than 90° can reduce or even avoid the loss of energy density of the electrochemical apparatus.

In a possible embodiment, the second subsection includes at least two sections, and the included angle between adjacent sections is greater than or equal to 90°. The included angle being less than 90° can cause the second subsection to warp. Setting the included angle to be greater than 90° can reduce or even avoid the loss of energy density of the electrochemical apparatus.

In a possible embodiment, the second subsection includes n sections, the n-th section is connected to the side edge of the sealing piece, the distances from the intersections between the (n−1)th section close to the first subsection and the n-th section to the side edge of the tab do not exceed 2.5 mm. This multi-section arrangement allows the top edge of the sealing piece to fit better, improving the sealing performance of the electrochemical apparatus.

In a possible embodiment, a groove is further opened between the first subsection and the second subsection to absorb deformation of the sealing piece.

In a possible embodiment, along the extension direction of the tab, a distance between an end of the second section away from the first section and the sealing edge of the packaging bag and a distance between an end of the third section away from the first section and the sealing edge of the packaging bag are both greater than or equal to 0.1 mm. This arrangement can prevent the second section or the third section from entering the sealing region and affecting the sealing performance of the electrochemical apparatus.

In a possible embodiment, the electrochemical apparatus further includes a circuit board, where the circuit board is located on a side of the sealing piece and covers part of the sealing piece exposed by the packaging bag, and an end of the tab protruding from the packaging bag is bent toward the circuit board and connected to the circuit board.

In a possible embodiment, the packaging bag is rectangular, and along the extension direction of the tab, vertical distances from any points on the sealing edge to the first section of the top edge are identical. Thus, the shape of the sealing edge may be regular and stable, helping increase the sealing effect.

An embodiment of this application provides an electronic device, which includes a housing, an electronic component connection line, and the electrochemical apparatus of the above embodiments. The electronic component connection line and the electrochemical apparatus are disposed in the housing, and the electronic component connection line is electrically connected to the electrochemical apparatus.

In a possible embodiment, the housing includes an accommodating cavity, the electrochemical apparatus is mounted in the accommodating cavity, and the top edge of the sealing piece of the electrochemical apparatus does not exceed the accommodating cavity.

An embodiment of this application provides a manufacturing method for electrochemical apparatus, used for manufacturing the above electrochemical apparatus. The manufacturing method for electrochemical apparatus includes: die-cutting the top edge of the sealing piece, such that the top edge of the sealing piece forms the first section, the second section, and the third section, where the second section and the third section are respectively located on two sides of the first section, and along the width direction of the tab, the length of the first section is A, the length of the bottom edge is B, and the width of the tab is C, meeting B>A≥C; and along the extension direction of the tab, the distance from any point on the second section and the third section to the bottom edge is less than a distance between the first section and the bottom edge;
welding the tab to the electrode plate, and winding or stacking the electrode plate to form the battery cell;
preparing the tab, and adhering the sealing piece to the tab;
placing the battery cell into the packaging bag, where the tab protrudes from the sealing edge of the packaging bag, the packaging bag covers part of the sealing piece, the top edge of the sealing piece is located outside the packaging bag, and the bottom edge is located inside the packaging bag; and
hot pressing and sealing the packaging bag, where the sealing piece is sealingly connected between the packaging bag and the tab.

In a possible embodiment, in the step of hot pressing and sealing the packaging bag, a hot pressing pressure is 120±50 Kgf, and a hot pressing temperature is 190±5° C.

In a possible embodiment, a thickness of the sealing piece is 30 μm-80 μm.

In a possible embodiment, after the die-cutting the top edge of the sealing piece, the distance between two ends of the second section or the third section is a height H₁ of the second section or the third section, where 0.15 mm≤H₁≤0.7 mm; and after the step of hot pressing and sealing the packaging bag, the height of the second section or the third section is H, where 0.05 mm≤H≤0.5 mm. This arrangement can pre-reserve the extension position of the sealing piece during hot pressing, preventing the second section or the third section of the sealing piece from exceeding the first section of the sealing piece after the step of hot pressing and sealing the packaging bag. This helps reduce the warping of the sealing piece in the length direction of the electrochemical apparatus and the warping in the thickness direction, thereby reducing the loss of energy density.

In a possible embodiment, 0.3 mm≤H₁≤0.5 mm, and after the step of hot pressing and sealing the packaging bag, 0.15 mm≤H≤0.3 mm. This arrangement helps further reduce the warping amount of the sealing piece and increase the energy density of the electrochemical apparatus, and does not significantly compromise the leakage rate of the electrochemical apparatus.

In a possible embodiment, after the die-cutting of the top edge of the sealing piece, the difference between the length B₁ of the bottom edge of the sealing piece and the length A₁ of the first section is 0.2<B₁−A₁≤8.3 mm. After the step of hot pressing and sealing the packaging bag, 0<B−A≤8 mm. When 0.2<B₁−A₁≤8.3, the extension position of the sealing piece can be pre-reserved during hot pressing, preventing the length of the first section of the sealing piece from exceeding the length of the bottom edge of the sealing piece after the step of hot pressing and sealing the packaging bag. This helps reduce the warping of the sealing piece in the length direction of the electrochemical apparatus and the warping in the thickness direction, thereby reducing the loss of energy density.

In a possible embodiment, 2.1 mm≤B₁−A₁≤8.3 mm, and after the step of hot pressing and sealing the packaging bag, 1.8 mm≤B−A≤8 mm. This arrangement helps further reduce the warping amount of the sealing piece.

In a possible embodiment, 3.3 mm≤B₁−A₁≤7.3 mm; and after the step of hot pressing and sealing the packaging bag, 3 mm≤B−A≤7 mm. This arrangement helps further reduce the warping amount of the sealing piece and allows for a high energy density of the electrochemical apparatus, and does not significantly compromise the leakage rate of the electrochemical apparatus.

In a possible embodiment, after the die-cutting the top edge of the sealing piece, the length from the end of the second section or the third section connected to the first section to the tab is W, where 0.2 mm≤W1≤1.3 mm. After the step of hot pressing and sealing the packaging bag, 0.3 mm≤W≤1.1 mm.

In a possible embodiment, a distance between a side edge of the sealing piece and a corresponding side edge of the tab is X, where 0.3 mm≤X≤4.5 mm.

In a possible embodiment, along the extension direction of the tab, a distance between the first section and the bottom edge is a height Y of the sealing piece, where 3.5 mm≤Y≤12.5 mm.

In a possible embodiment, the second section and/or the third section includes the first subsection and the second subsection, where the first subsection is located between the first section and the second subsection, the second subsection includes at least one section, an endpoint connecting the first subsection and the first section is M₁, an endpoint connecting the second subsection and the side edge of the sealing piece is N₁, the connection endpoint M₁ and the connection endpoint N₁ form a line segment M₁N₁, and an included angle between the first section and the line segment M₁N₁ is greater than or equal to 90°.

In a possible embodiment, the second subsection includes at least two sections, and the included angle between adjacent sections is greater than or equal to 90°.

In a possible embodiment, the second subsection includes the n sections, and the n-th section is connected to the side edge of the sealing piece; after the die-cutting the top edge of the sealing piece, a distance from an intersection between the n-th section to the side edge of the tab does not exceed 2 mm; and after the step of hot pressing and sealing the packaging bag, the distances from the intersections between the (n−1)th section close to the first subsection and the n-th section to the side edge of the tab do not exceed 2.5 mm.

In this embodiment of the manufacturing method, the beneficial effects of various parameters of the sealing piece after hot pressing and sealing are roughly the same as those in the previous embodiments and will not be repeated herein. Before hot pressing and sealing, a cutting size parameter of part of the sealing piece is greater than that of part of the sealing piece after hot pressing and sealing, to reserve a certain deformation margin and tolerance range for the subsequent hot melting deformation of the sealing piece during the cutting stage, allowing the deformation amount of the sealing piece to be within a controllable range, thereby avoiding problems such as the sealing piece extending outward or warping after hot sealing.

According to the electrochemical apparatus, the electronic device, and the manufacturing method of this application, the height difference between the second section and the first section and the height difference between the third section and the first section are formed, such that the second section and the third section do not exceed the first section. The height difference between the second section and the first section and the height difference between the third section and the first section can reduce the impact caused by the outward-extending deformation of the sealing piece, helping reduce the exposed length of the sealing piece. After the tab is bent, because the sealing piece does not have a warping problem, the sealing piece has a reduced exposed length, and does not protrude relative to the battery cell in the thickness direction of the battery cell, thereby reducing the overall length and thickness of the electrochemical apparatus, and increasing the energy density of the electrochemical apparatus.

### BRIEF DESCRIPTION

To describe the technical solutions of the embodiments of this application more clearly, the following briefly describes the accompanying drawings in the embodiments. It is appreciated that the accompanying drawings below show merely some embodiments of this application and thus should not be considered as limitations on the scope. Persons of ordinary skill in the art may still derive other related drawings from the accompanying drawings without creative efforts.

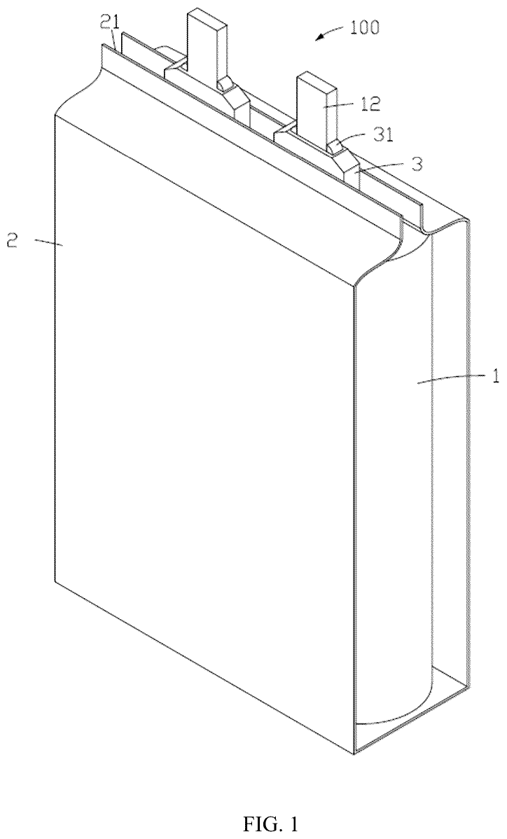

FIG. 1 is a schematic structural diagram of an electrochemical apparatus according to an embodiment of this application.

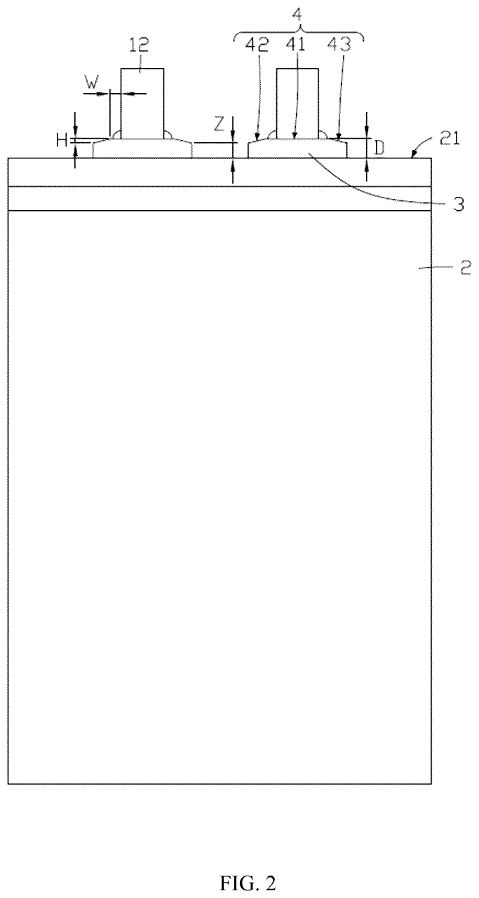

FIG. 2 is a front view of the electrochemical apparatus shown in FIG. 1.

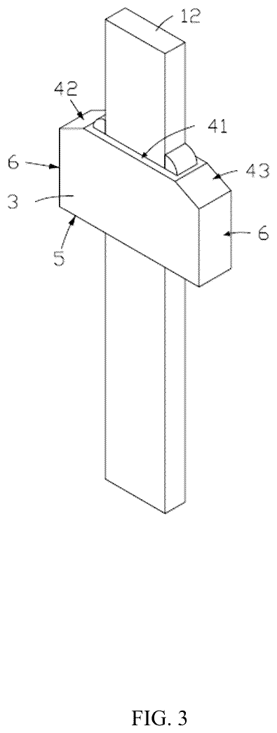

FIG. 3 is a schematic structural diagram of a tab and a sealing piece in the electrochemical apparatus shown in FIG. 1.

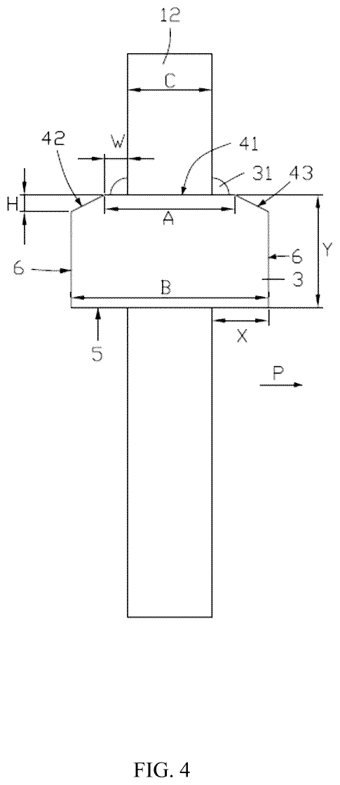

FIG. 4 is a front view of a structure shown in FIG. 3.

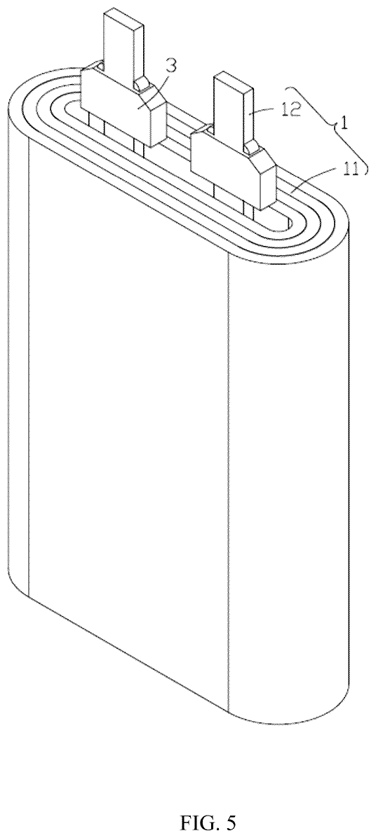

FIG. 5 is a schematic structural diagram of a battery cell and a sealing piece in the electrochemical apparatus shown in FIG. 1.

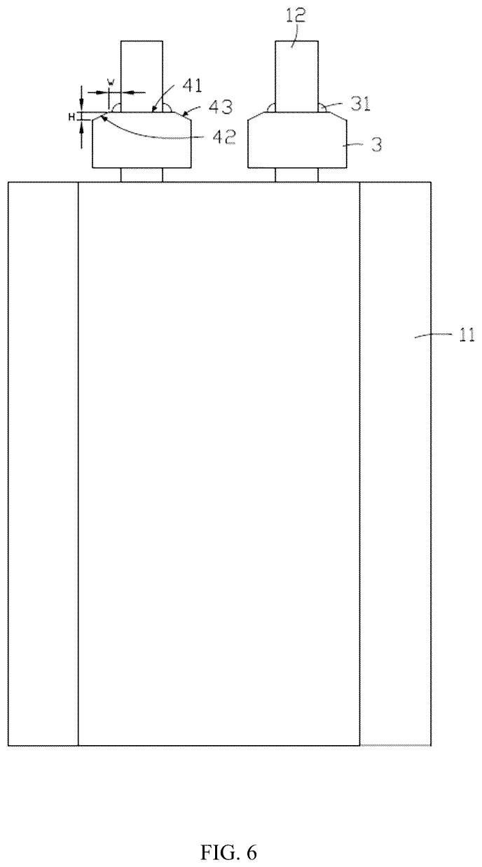

FIG. 6 is a front view of a structure shown in FIG. 5.

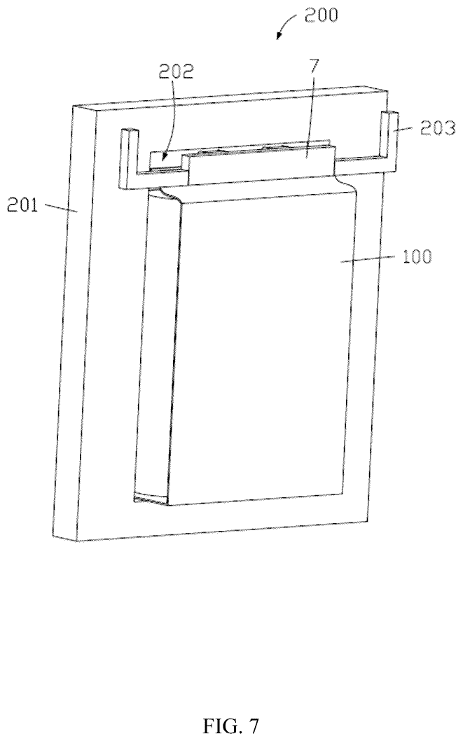

FIG. 7 is a schematic structural diagram of the electrochemical apparatus being assembled into an electronic apparatus as shown in FIG. 1.

FIG. 8 is a front view of a structure shown in FIG. 7.

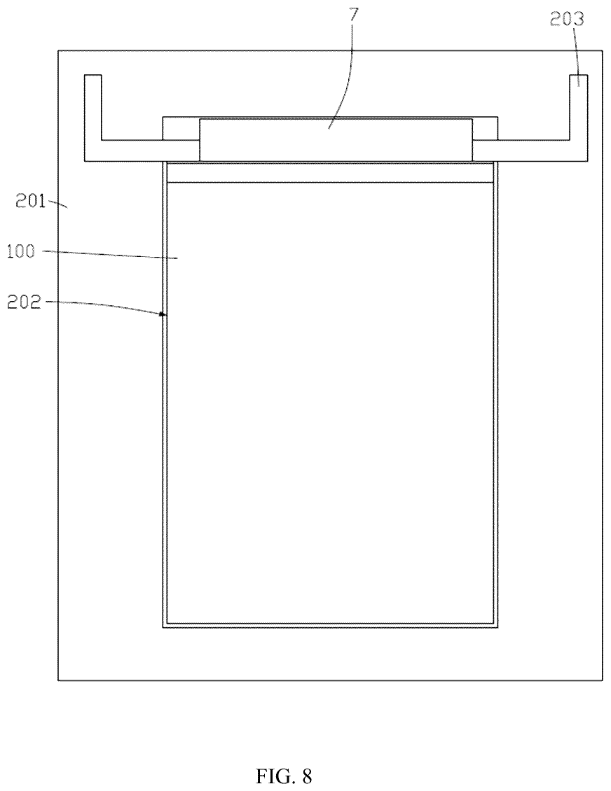

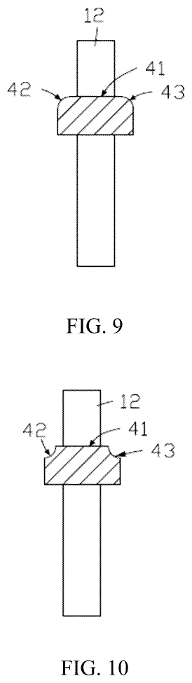

FIG. 9 is a schematic structural diagram of the tab and the sealing piece of the electrochemical apparatus according to an embodiment.

FIG. 10 is a schematic structural diagram of the tab and the sealing piece of the electrochemical apparatus according to an embodiment.

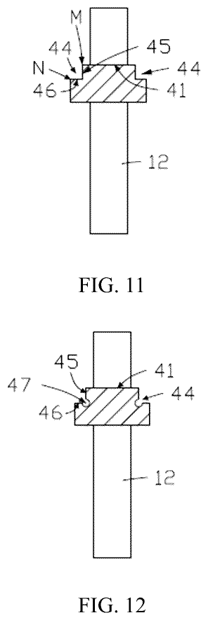

FIG. 11 is a schematic structural diagram of the tab and the sealing piece of the electrochemical apparatus according to an embodiment.

FIG. 12 is a schematic structural diagram of the tab and the sealing piece of the electrochemical apparatus according to an embodiment.

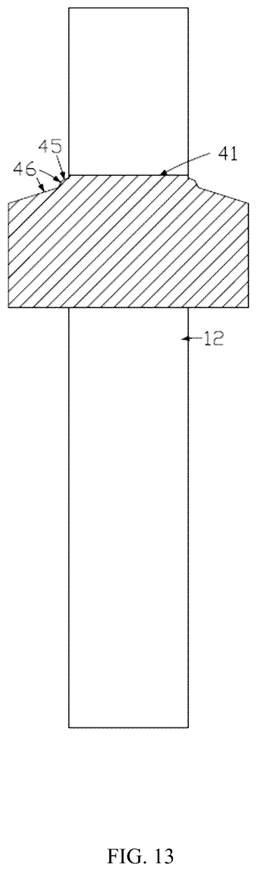

FIG. 13 is a schematic structural diagram of the tab and the sealing piece of the electrochemical apparatus according to an embodiment.

FIG. 14 is a schematic structural diagram of a battery cell and a sealing piece in the prior art.

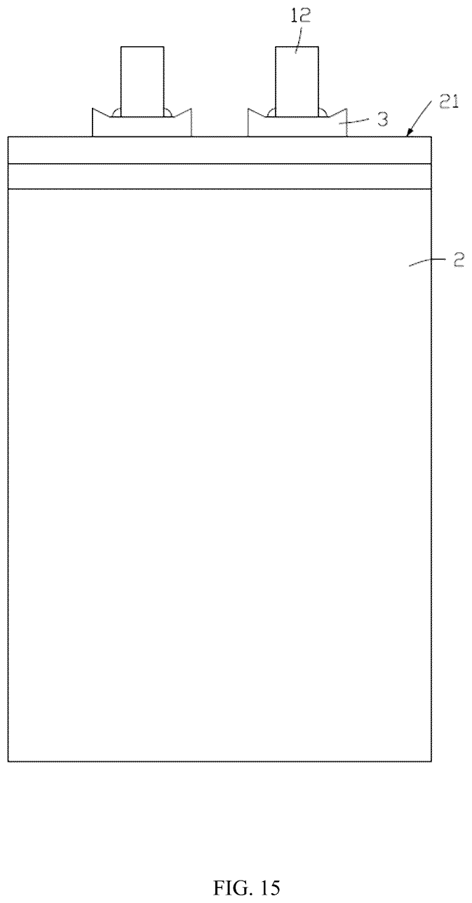

FIG. 15 is a schematic structural diagram of the sealing piece deforming (warping) after hot pressing and sealing of the electrochemical apparatus in the prior art.

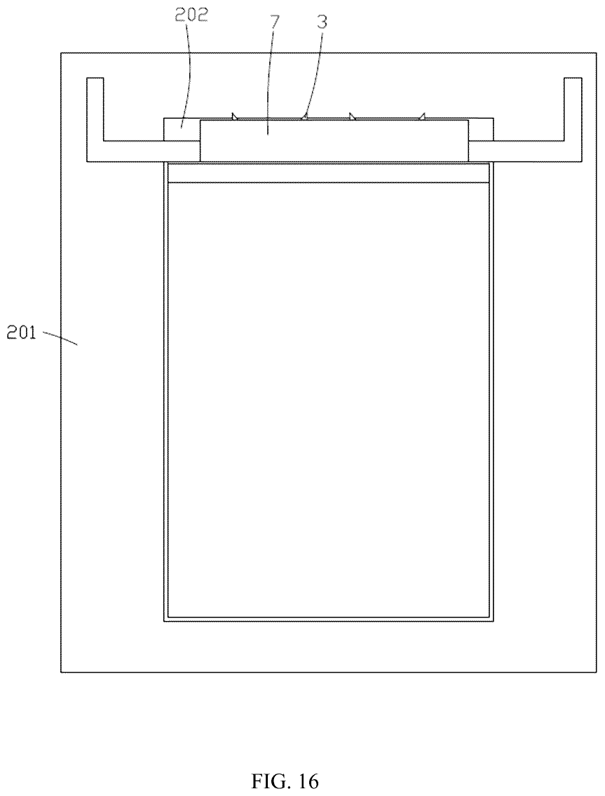

FIG. 16 is a schematic structural diagram of assembly interference between an electrochemical apparatus and an electronic device in the prior art.

### REFERENCE SIGNS OF MAIN COMPONENTS

Electrochemical apparatus 100
Battery cell 1
Electrode plate 11
Tab 12
Packaging bag 2
Sealing edge 21
Sealing piece 3
Glue overflow portion 31
Top edge 4
First section 41
Second section 42
Third section 43
Depression 44
First subsection 45
Second subsection 46
Groove 47
Bottom edge 5
Side edge 6
Circuit board 7
Electronic device 200
Housing 201
Accommodating cavity 202
Electronic component connection line 203

This application will be further described with reference to the accompanying drawings in the following specific embodiments.

### DESCRIPTION OF EMBODIMENTS

The following clearly and completely describes the technical solutions in some embodiments of this application with reference to the accompanying drawings in some embodiments of this application. Apparently, the described embodiments are some but not all embodiments of this application.

It should be noted that when a component is referred to as being “fastened to” another component, it may be directly fastened to the another component, or there may be a component in between. When a component is deemed as being “connected to” another component, it may be directly connected to the another component, or there may be a component in between. When a component is deemed as being “provided on” another component, it may be directly provided on the another component, or there may be a component in between. The terms “vertical”, “horizontal”, “left”, “right”, and other similar expressions as used herein are for illustration only.

Unless otherwise defined, all technical and scientific terms used herein shall have the same meanings as commonly understood by persons skilled in the art to which this application belongs. The terms used herein in the specification of this application are merely intended to describe specific embodiments but not intended to limit this application. The term “and/or” used herein includes any and all combinations of one or more related listed items.

Some embodiments of this application are described in detail. Provided that there is no conflict, the following embodiments and features in an embodiment may be combined with each other.

Referring to FIGS. 1 to 4, an embodiment provides an electrochemical apparatus 100, including a battery cell 1, a packaging bag 2, and a sealing piece 3. The battery cell 1 includes an electrode plate 11 and a tab 12 connected to the electrode plate 11. The battery cell 1 is disposed in the packaging bag 2, and the tab 12 protrudes from a sealing edge 21 of the packaging bag 2. The sealing piece 3 is disposed on both side of the tab 12, the packaging bag 2 covers part of the sealing piece 3, the sealing piece 3 includes a top edge 4 and a bottom edge 5 opposite each other, the top edge 4 is located outside the packaging bag 2, and the bottom edge 5 is located inside the packaging bag 2. The top edge 4 includes a first section 41, a second section 42, and a third section 43, the second section 42 and the third section 43 are respectively located on two sides of the first section 41, and along a width direction of the tab 12, a length of the first section 41 is A, a length of the bottom edge 5 is B, and a width of the tab 12 is C, meeting B>A≥C. Along an extension direction of the tab 12, a distance from any point on the second section 42 and the third section 43 to the bottom edge 5 is less than a distance between the first section 41 and the bottom edge 5.

Thus, along the extension direction of the tab 12, the second section 42 and the third section 43 do not exceed the first section 41. The height difference between the second section 42, the third section 43, and the first section 41 can reduce the impact caused by the outward-extending deformation of the sealing piece 3, reduce the exposed size and warping amount of the sealing piece 3, and alleviate the problem of the top edge 4 of the sealing piece 3 deforming and warping due to excessive length of the top edge 4 during the assembly of the electrochemical apparatus 100, otherwise such problem leads to interference between the electrochemical apparatus 100 and the battery compartment. In addition, reducing the warping amount in the thickness direction of the electrochemical apparatus 100 can reduce the loss of energy density of the electrochemical apparatus 100. After the tab 12 is bent, because there is no warping problem with the sealing piece 3, and the size of the sealing piece 3 in the thickness direction of the electrochemical apparatus 100 is reduced, the overall thickness of the electrochemical apparatus 100 is reduced, increasing the energy density of the electrochemical apparatus 100.

In an embodiment of this application, the sealing piece 3 shown in FIGS. 1 to 6 is formed by sandwiching two opposite sides of the tab 12 between two sealing films and then performing hot melting and sealing, such that the sealing piece 3 can surround the periphery of the tab 12, which helps improve the sealing effect between the tab 12 and the packaging bag 2. In other embodiments, the sealing piece 3 may alternatively be formed by placing a sealing film on the surface of the tab 12 and then performing hot melting and sealing, or by clamping the tab 12 with multiple sealing films to meet actual sealing requirements. This application is not limited thereto. The size relationship between the above sections and the bottom edge is the size relationship after hot melting of the sealing piece.

In an embodiment of this application, the second section 42 is obliquely connected to an end of the first section 41 and a side edge 6 of the sealing piece 3, and the third section 43 is obliquely connected to another end of the first section 41 and another side edge 6 of the sealing piece 3, such that the second section 42 and the third section 43 form chamfered structures on two sides of the top edge 4 of the sealing piece 3. The second section 42 and the third section 43 may be formed by cutting the top edge 4 of the sealing piece 3, and the cutting process may be performed before the tab 12 is connected to the electrode plate 11. In other words, before the packaging process, the second section 42 and the third section 43 have already been formed on the top edge 4 of the sealing piece 3. Thus, when the exposed part of the sealing piece 3 deforms during the hot pressing process, the chamfered regions at the second section 42 and the third section 43 can absorb the deformation amount, alleviating the problem of the deforming edge extending beyond the first section 41 along the extension direction of the tab 12, thereby avoiding an increase in the exposed length of the sealing piece 3. It should be noted that the first section 41 is not necessarily straight. After hot pressing and sealing, the first section 41 may slightly protrude outward in the extension direction of the tab 12. Under the pressure of the hot pressing equipment, the protrusion amount of the first section 41 is small.

A glue overflow portion 31 is further formed between the two sides of the tab 12 and the first section 41, and is naturally formed during the hot pressing process of the sealing piece 3. In actual production, the size and proportion of the glue overflow portion 31 are much less than those shown in the drawings. After being bent, the tab 12 shields the glue overflow portion 31, or the glue overflow portion 31 bends along with the tab 12. The impact of the glue overflow portion 31 on the size of the electrochemical apparatus 100 may be ignored. The accompanying drawings of this application are to show the structure of the glue overflow portion 31, and size and proportion of the glue overflow portion 31 in the drawings are enlarged.

Still referring to FIGS. 5 and 6, the battery cell 1 further includes a separator, and the electrode plate 11 further includes a positive electrode plate and a negative electrode plate. The separator is placed between the positive electrode plate and the negative electrode plate to avoid short circuit problems caused by contact between the positive and negative electrode plates. The tab 12 is provided in two. One tab 12 is connected to the positive electrode plate, and the other tab 12 is connected to the negative electrode plate. Each tab 12 is provided with a corresponding sealing piece 3, and each sealing piece 3 is formed by sandwiching the tab 12 between at least two sealing films and then performing hot melting. In an embodiment of this application, the positive electrode plate, the separator, and the negative electrode plate are wound or stacked to form the battery cell 1, and the two tabs 12 are two located at the same end of the battery cell 1. It may be understood that in other embodiments, the two tabs 12 may alternatively be located at different ends of the battery cell 1, and the number of tabs 12 may be more than two. This application is not limited thereto. The positive electrode plate, the separator, and the negative electrode plate may alternatively form the battery cell 1 by stacking multiple layers. This application does not limit the arrangement form of the electrode plate 11 of the battery cell 1.

As shown in FIG. 4, in a possible embodiment of this application, A<B, and the difference between the length B of the bottom edge 5 of the sealing piece 3 and the length A of the first section 41 is B−A, where 0<B−A≤8 mm, such that the length A of the first section 41 is less than the length B of the bottom edge 5, and the second section 42 and the third section 43 may be formed on two sides of the first section 41. If the width of the bottom edge 5 is constant, when the value of B−A is too large, the difference between the length of the first section 41 and the width of the tab 12 is too small, which is likely to cause cracking at the joint between the sealing piece 3 and the tab during assembly, form a leakage channel, and increase the electrolyte leakage rate of the electrochemical apparatus 100. Additionally, an increase in the value of B−A also increases the risk of the second section 42 or the third section 43 of the sealing piece 3 entering the sealing part of the packaging bag 2 of the electrochemical apparatus 100, thereby increasing the electrolyte leakage rate of the electrochemical apparatus 100. Further, 1.8 mm≤B−A≤8 mm, such that the two ends of the first section 41 can form distinct second section 42 and third section 43, reducing the exposed size and warping amount of the sealing piece 3, alleviating interference problems during assembly, and reducing the loss of energy density of the electrochemical apparatus, while not causing a high electrolyte leakage rate of the electrochemical apparatus. Further, in an embodiment, the difference B−A between the length B of the bottom edge 5 of the sealing piece 3 and the length A of the first section 41 is preferably 3 mm≤B−A≤7 mm, which helps further reduce the exposed size of the sealing piece 3 and ensures the sealing performance of the electrochemical apparatus 100. It should be noted that the parameter range of the difference B−A between the length B of the bottom edge 5 and the length A of the first section 41 is the parameter range after hot sealing of the sealing piece 3, to ensure that the top edge 4 of the sealing piece 3 has no part extending outward and deforming, achieving the objective of reducing the exposed size of the sealing piece 3. When the length A is measured, due to the influence of hot melting, there is a protrusion on the top edge 4 in the extension direction of the tab 12. Two endpoints of the first section 41 are selected at the turning positions at which the distances from the top edges 4 on two sides of the tab 12 to the bottom edge 5 decrease, and the distance between the two endpoints is the length A of the first section 41. When the length B is measured, the distance between the two side edges 6 of the sealing piece 3 is measured. If the turning positions on the two sides of the tab cannot be determined, the length A of the first section 41 may be tested after downward movement by 0.04 mm from the highest point of the bulge on the top edge 4.

In an embodiment of this application, along the extension direction of the tab 12, a distance between two ends of the second section 42 or the third section 43 is a height H of the second section 42 or the third section 43, where 0.05 mm≤H≤0.5 mm. In an embodiment of this application, the distance H between the two ends of the second section 42 is the vertical distance between the left endpoint of the top edge 4 and the left endpoint of the first section 41 along the extension direction of the tab 12; and the distance H between the two ends of the third section 43 is the vertical distance between the right endpoint of the top edge 4 and the right endpoint of the first section 41 along the extension direction of the tab 12. The measurement method for the first section 41 is described in the above embodiments and is not elaborated herein. The parameter range of H is also the height parameter range of the second section 42 and/or the third section 43 of the sealing piece 3 after hot melting. To be specific, the height difference between the second section 42 and the first section 41 and the height difference between the third section 43 and the first section 41 after hot sealing are in the range of 0.05 mm-0.5 mm, ensuring that the second section 42 and the third section 43 do not exceed the first section 41, which can reduce the impact caused by the outward-extending deformation of the sealing piece 3, thereby achieving the objective of reducing the exposed size of the sealing piece 3, and alleviating interference problems during subsequent assembly. In addition, the height difference between the second section 42 and the first section 41 and the height difference between the third section 43 and the first section 41 allow part of the sealing piece 3 within this range to bend together with the tab 12, thereby reducing the size of the electrochemical apparatus 100 in the length direction and increasing the energy density of the electrochemical apparatus 100. When the value of H exceeds the preset range, a larger value of H indicates a greater risk of the second section 42 and the third section 43 of the sealing piece 3 entering the sealing part of the packaging bag 2, thus reducing the sealing performance of the electrochemical apparatus 100 and increasing the electrolyte leakage rate. In an embodiment of this application, the heights of the second section 42 and the third section 43 are the same and are symmetrically arranged on two sides of the first section 41. This symmetrical arrangement helps maintain the uniformity of the packaging effect and reduce the preparation process. In other embodiments, the heights of the second section 42 and the third section 43 may alternatively be different to meet actual design requirements.

Further, in an embodiment, the height H of the second section 42 or the third section 43 is preferably 0.15 mm≤H≤0.3 mm. This parameter range is also the height parameter range of the second section 42 and/or the third section 43 of the sealing piece 3 after hot melting, so as to further reduce the exposed size of the sealing piece 3. This can improve the energy density performance of the electrochemical apparatus 100, alleviate the leakage problem, and meet subsequent assembly requirements.

In a direction from a side edge 6 of the sealing piece 3 to another side edge 6, that is, along the width direction P of the sealing piece 3, a distance from one end of the second section 42 or the third section 43 connected to the first section 41 to the tab 12 is W, meaning that a shoulder width of the top edge of the sealing piece 3 is W, where 0.3 mm≤W≤1.1 mm. This parameter range is also the parameter range of the shoulder width of the top edge 4 of the sealing piece 3 after hot melting of the sealing piece 3, which helps maintain the covering effect of the sealing piece 3 on the tab 12 and ensures the sealing performance between the tab 12 and the packaging bag 2.

Further, in a possible embodiment of this application, along the width direction P of the sealing piece 3, the distance between the side edge 6 of the sealing piece 3 and the corresponding side edge 6 of the tab 12 is X, meaning that the shoulder width of the bottom edge of the sealing piece 3 is X, where 0.3 mm≤X≤4.5 mm, such that an end of the bottom edge 5 of the sealing piece 3 exceeds an end of the first section 41, increasing the contact area of the sealing piece 3 in the packaging bag 2, which helps ensure the sealing effect between the tab 12 and the packaging bag 2.

Along the extension direction of the tab 12, the distance between the first section 41 and the bottom edge 5 is the height Y of the sealing piece 3, where 3.5 mm≤Y≤12.5 mm. A suitable value may be chosen based on the size of the tab 12 to maintain the sealing effect between the tab 12 and the packaging bag 2 while reasonably planning the height dimensions of the sealing piece 3, alleviating the problem of the increase in the overall size of the electrochemical apparatus 100 caused by excessive exposure of the sealing piece 3.

Stilling referring to FIG. 2, in an embodiment of this application, along the extension direction of the tab 12, the distance Z between an end of the second section 42 away from the first section 41 and the sealing edge 21 of the packaging bag 2 and the distance Z between an end of the third section 43 away from the first section 41 and the sealing edge 21 of the packaging bag 2 are both greater than or equal to 0.1 mm, reducing the risk of poor sealing and electrolyte leakage caused by embedding the second section or the third section into the sealing region of the packaging bag 2. Along the extension direction of the tab 12, the exposed length of the sealing edge 21 of the sealing piece 3 is D, where Z<D, such that the top edge 4 of the sealing piece 3 can form the second section 42 and the third section 43. Further, the packaging bag 2 of this application is approximately rectangular. Along the extension direction of the tab 12, the vertical distances from any points on the sealing edge 21 to the first section 41 of the top edge 4 of the sealing piece 3 are the same. Thus, the shape of the sealing edge 21 is regular and stable, which can balance the sealing effect of various parts of the sealing region of the packaging bag 2, helping improve the sealing effect, reduce stress concentration problems, and reduce the risk of weak sealing regions and leakage. It should be noted that the vertical distances from any points on the sealing edge 21 to the first section 41 of the top edge 4 of the sealing piece 3 are the same, which does not mean the distances are absolutely identical. When comparing the vertical distances from any two points on the sealing edge 21 to the first section 41, vertical distances with an error of within +3% may be considered the same.

Table 1 and Table 2 show the dimensional parameters of the sealing piece before and after hot pressing in each example, including: the length A of the first section 41, the length B of the bottom edge 5, the difference B−A between the lengths of the first section 41 and the bottom edge 5, the height H of the second section 42 and the third section 43, the shoulder width X of the bottom edge of the sealing piece 3, the shoulder width W of the top edge of the sealing piece 3, and the length D of the sealing piece 3 exposed from the sealing edge 21.

TABLE 1
Dimensional parameters of sealing pieces in
various examples before hot pressing
Before hot pressing (in mm)

| | | | | H₁ | X | W₁ | |
|---|---|---|---|---|---|---|---|
| | | | B₁ − A₁ | 0.15 ≤ | 0.3 < | 0.2 ≤ | |
| | | | 0.2 < B − | H₁ ≤ | X ≤ | W ≤ | |
| | A₁ | B₁ | A ≤ 8.3 | 0.7 | 4.5 | 1.3 | D |
| Example 1 | 2.7 | 11 | 8.3 | 0.5 | 4.3 | 0.45 | 1 |
| Example 2 | 10.5 | 11 | 0.5 | 0.5 | 0.4 | 0.45 | 1 |
| Example 3 | 6.3 | 11 | 4.7 | 0.7 | 2.5 | 0.45 | 1 |
| Example 4 | 7.7 | 11 | 3.3 | 0.5 | 1.8 | 0.45 | 1 |
| Example 5 | 7.7 | 11 | 3.3 | 0.15 | 1.8 | 0.45 | 1 |
| Example 6 | 7.7 | 11 | 3.3 | 0.6 | 1.8 | 0.45 | 1 |
| Example 7 | 7.7 | 11 | 3.3 | 0.3 | 1.8 | 0.45 | 1 |
| Example 8 | 7.7 | 11 | 3.3 | 0.3 | 1.8 | 0.45 | 1 |
| Example 9 | 7.7 | 11 | 3.3 | 0.5 | 2.6 | 1.25 | 1 |
| Example 10 | 3.7 | 11 | 7.3 | 0.5 | 3.8 | 0.45 | 1 |
| Example 11 | 8.9 | 11 | 2.1 | 0.5 | 1.2 | 0.45 | 1 |
| Example 12 | 9.7 | 11 | 1.3 | 0.5 | 0.8 | 0.45 | 1 |
| Example 13 | 8.3 | 11 | 2.7 | 0.5 | 1.5 | 0.45 | 1 |
| Example 14 | 6.5 | 11 | 4.5 | 0.5 | 2.4 | 0.45 | 1 |
| Example 15 | 4.7 | 11 | 6.3 | 0.5 | 3.3 | 0.45 | 1 |
| Example 16 | 3.3 | 11 | 7.7 | 0.5 | 4 | 0.45 | 1 |
| Example 17 | 8.3 | 11 | 2.7 | 0.5 | 1.8 | 0.75 | 1 |
| Example 18 | 8.9 | 11 | 2.1 | 0.5 | 1.8 | 1.05 | 1 |
| Example 19 | 7.7 | 11 | 3.3 | 0.5 | 1.8 | 0.45 | 1 |
| Example 20 | 2.5 | 11 | 8.5 | 0.5 | 4.4 | 0.45 | 1 |
| Comparative | 7.7 | 11 | 3.3 | 0.8 | 1.8 | 0.45 | 1 |
| example 1 | | | | | | | |
| Comparative | 7.7 | 11 | 3.3 | 0.24 | 1.8 | 0.45 | 1 |
| example 2 | | | | | | | |
| Comparative | 11 | 11 | 0 | 0 | 2.5 | 2.5 | 1 |
| example 3 | | | | | | | |

TABLE 2
Dimensional parameters and technical effects of sealing
pieces in various examples after hot pressing

| After hot pressing (in mm) | | | | | | | | | |
|---|---|---|---|---|---|---|---|---|---|
| | | | B − A | H | X | W | | Energy | |
| | | | 0 < B − | 0.05 ≤ | 0.3 < | 0.3 ≤ | | density | Electrolyte |
| | A | B | A ≤ 8 | H ≤ 0.5 | X ≤ 4.5 | W ≤ 1.1 | D | (Wh/L) | leakage rate |
| Example 1 | 3 | 11 | 8 | 0.3 | 4.3 | 0.3 | 1 | 708.52 | 0.000265% |
| Example 2 | 10.8 | 11 | 0.2 | 0.3 | 0.4 | 0.3 | 1 | 706.27 | 0.000124% |
| Example 3 | 6.6 | 11 | 4.4 | 0.5 | 2.5 | 0.3 | 1 | 709.09 | 0.000274% |
| Example 4 | 8 | 11 | 3 | 0.3 | 1.8 | 0.3 | 1 | 707.66 | 0.000200% |
| Example 5 | 8 | 11 | 3 | 0.05 | 1.8 | 0.3 | 1 | 705.70 | 0.000125% |
| Example 6 | 8 | 11 | 3 | 0.4 | 1.8 | 0.3 | 1 | 708.50 | 0.000220% |
| Example 7 | 8 | 11 | 3 | 0.15 | 1.8 | 0.3 | 1 | 706.83 | 0.000155% |
| Example 8 | 8 | 11 | 3 | 0.1 | 1.8 | 0.3 | 1 | 706.41 | 0.000148% |
| Example 9 | 8 | 11 | 3 | 0.3 | 2.6 | 1.1 | 1 | 706.55 | 0.000185% |
| Example 10 | 4 | 11 | 7 | 0.3 | 3.8 | 0.3 | 1 | 708.10 | 0.000247% |
| Example 11 | 9.2 | 11 | 1.8 | 0.3 | 1.2 | 0.3 | 1 | 706.97 | 0.000145% |
| Example 12 | 9.4 | 11 | 1.6 | 0.3 | 1 | 0.2 | 9.4 | 706.69 | 0.000135% |
| Example 13 | 8.6 | 11 | 2.4 | 0.3 | 1.5 | 0.3 | 1 | 707.11 | 0.000168% |
| Example 14 | 6.8 | 11 | 4.2 | 0.3 | 2.4 | 0.3 | 1 | 707.82 | 0.000225% |
| Example 15 | 5 | 11 | 6 | 0.3 | 3.3 | 0.3 | 1 | 707.96 | 0.000235% |
| Example 16 | 3.6 | 11 | 7.4 | 0.3 | 4 | 0.3 | 1 | 708.24 | 0.000250% |
| Example 17 | 8.6 | 11 | 2.4 | 0.3 | 1.8 | 0.6 | 1 | 707.25 | 0.000192% |
| Example 18 | 9.2 | 11 | 1.8 | 0.3 | 1.8 | 0.9 | 1 | 707.39 | 0.000188% |
| Example 19 | 8 | 11 | 2.8 | 0.3 | 1.8 | 0.3 | 1 | 707.53 | 0.000185% |
| Example 20 | 2.8 | 11 | 8.2 | 0.3 | 4.4 | 0.3 | 1 | 709.09 | 0.000305% |
| Comparative | 8 | 11 | 3 | 0.6 | 1.8 | 0.3 | 1 | 709.65 | 0.000505% |
| example 1 | | | | | | | | | |
| Comparative | 8 | 11 | 3 | 0.04 | 1.8 | 0.3 | 1.05 | 705.28 | 0.000120% |
| example 2 | | | | | | | | | |
| Comparative | 8 | 11 | 3 | −0.4 | 2.5 | 2.5 | 1.4 | 704.43 | 0.000115% |
| example 3 | | | | | | | | | |

From the comparison of the example data in Table 1 and Table 2, it can be seen that although the sealing piece 3 undergoes slight deformation after hot pressing, for example, the length A of the first section 41 increases, the heights H of the second section 42 and the third section 43 decrease, and the shoulder width W of the top edge of the sealing piece 3 increases, all parameters of the sealing piece 3 after hot pressing can still meet the foregoing conditions, and the length D of the sealing piece 3 protruding from the sealing side edge remains unchanged, being 1 mm before and after hot pressing. In the comparative examples, the sealing piece is rectangular, with the top edge and bottom edge having the same length, and the shoulder width of the top edge is also the same as the shoulder width of the bottom edge. The second section and the third section are not formed on two sides of the top edge. After hot pressing, the heights H of the second section 42 and the third section 43 protrude 0.4 mm along the extension direction of the tab, causing the length D of the sealing piece protruding from the sealing edge to significantly increase from 1 mm to 1.4 mm. This increases the overall length of the electrochemical apparatus 100, resulting in warping in the thickness direction, affecting energy density, and causing interference problems between the electrochemical apparatus 100 and the battery compartment during assembly.

Through data comparison between the examples and comparative examples, along the extension direction of the tab 12, a distance between two ends of the second section 42 or the third section 43 is a height H of the second section 42 or the third section 43, where 0.05 mm≤H≤0.5 mm. By ensuring that the second section 42 and the third section 43 do not exceed the first section 41, the impact caused by the outward-extending deformation of the sealing piece 3 can be reduced, thereby achieving the objective of reducing the exposed size of the sealing piece 3 and alleviating interference problems during subsequent assembly processes. In addition, the height difference between the second section 42 and the first section 41 and the height difference between the third section 43 and the first section 41 allow part of the sealing piece 3 within this range to bend together with the tab 12, thereby reducing the size of the electrochemical apparatus 100 in the length direction and increasing the energy density of the electrochemical apparatus 100. The data from Example 20, Comparative example 1, and Comparative example 2 demonstrate that when the value of H exceeds the preset range, a larger value of H indicates a greater risk of the second section 42 and the third section 43 of the sealing piece 3 entering the sealing part of the electrochemical apparatus 100, which reduces the sealing performance of the electrochemical apparatus 100 and increases the probability of leakage. Further, the height H of the second section 42 or the third section 43 is preferably 0.15 mm≤H≤0.3 mm. This parameter range is also the height parameter range of the second section 42 and/or the third section 43 of the sealing piece 3 after hot melting. This can further reduce the exposed size of the sealing piece 3, improve the energy density performance, alleviate leakage problems of the electrochemical apparatus 100, and meet subsequent assembly requirements. A<B, the difference between the length B of the bottom edge 5 of the sealing piece 3 and the length A of the first section 41 is B−A, and 0<B−A≤8 mm, such that the length A of the first section 41 is less than the length B of the bottom edge 5, and the second section 42 and the third section 43 can be formed on two sides of the first section 41. When the value of B−A is too large, that is, the difference between the length of the first section 41 and the width of the tab 12 is too small, it is easy to cause the tab adhesive to crack during assembly, forming a leakage channel and increasing the electrolyte leakage rate of the electrochemical apparatus. Additionally, an increase in the value of B−A also increases the risk of the second section 42 or the third section 43 of the sealing piece entering the sealing part of the packaging bag 2 of the electrochemical apparatus 100, thereby increasing the electrolyte leakage rate of the electrochemical apparatus 100. Further, 1.8 mm≤B−A≤8 mm, such that the two ends of the first section 41 can form distinct second section 42 and third section 43, reducing the exposed size and warping amount of the sealing piece 3, alleviating the interference problems during assembly, and reducing the loss of energy density of the electrochemical apparatus 100, while not causing the electrolyte leakage rate of the electrochemical apparatus 100 to be too high. Further, in an embodiment, the difference B−A between the length B of the bottom edge 5 of the sealing piece 3 and the length A of the first section 41 is preferably 3 mm≤B−A≤7 mm, which helps further reduce the exposed size of the sealing piece 3 and ensures the sealing performance of the electrochemical apparatus 100. In summary, it is sufficient to prove that the sealing piece structure in some embodiments of this application can reduce the impact caused by the outward-extending deformation of the top edge, reduce the exposed size of the sealing size 3, and alleviate the problem of the top edge 4 of the sealing piece 3 deforming and warping due to excessive length during the assembly of the electrochemical apparatus 100, otherwise such problem leads to interference between the electrochemical apparatus 100 and the battery compartment. Additionally, the sealing piece structure can also reduce the high electrolyte leakage rate of the electrochemical apparatus 100, otherwise such high rate affects the production yield of the electrochemical apparatus 100.

Referring to FIGS. 7 and 8, in a possible embodiment of this application, the electrochemical apparatus 100 further includes a circuit board 7, where the circuit board 7 is located on a side of the sealing piece 3 and covers part of the sealing piece 3 exposed by the packaging bag 2, and an end of the tab 12 protruding from the packaging bag 2 is bent toward the circuit board 7 and connected to the circuit board 7. Because the arrangement of the second section 42 and the third section 43 can reduce the impact caused by the outward-extending deformation of the top edge 4 of the sealing piece 3, along the extension direction of the tab 12, the second section 42 and the third section 43 do not exceed the first section 41. When the circuit board 7 covers the first section 41, it may cover the exposed part of the sealing piece 3, and the top edge 4 of the sealing piece 3 does not exceed the edge of the circuit board 7. Therefore, the overall size of the electrochemical apparatus 100 is reduced, helping to increase the energy density of the electrochemical apparatus 100. During assembly of the electrochemical apparatus 100 into the electronic device 200, interference problems are also less likely to occur, reducing space occupied by the electrochemical apparatus 100 in the electronic device 200.

Referring to FIGS. 9 and 10, in a possible embodiment of this application, the second section 42 is an arc section connected between an end of the first section 41 and a side edge 6 of the sealing piece 3, and the second section 42 is recessed toward a side edge 6 of the tab 12 or the second section 42 is bent toward an outer side of the sealing piece 3. A rounded corner structure is formed at the end of the top edge 4 of the sealing piece 3. The rounded corner structure can reduce the sharp parts presented at the end of the top edge 4 of the sealing piece 3, reducing the warping of the sealing piece. The second section 42 does not exceed the first section 41 along the extension direction of the tab 12, and the shoulder width W of the top edge of the sealing piece 3 and the height H of the second section 42 meet the parameter requirements of the aforementioned embodiments, achieving the objective of reducing the exposed size of the sealing piece 3.

The third section 43 is an arc section connected between another end of the first section 41 and another side edge 6 of the sealing piece 3, and the third section 43 is recessed toward the side edge 6 of the tab 12 or the third section 43 is bent toward the outer side of the sealing piece 3. The third section 43 does not exceed the first section 41 along the extension direction of the tab 12, and the shoulder width W of the top edge of the sealing piece 3 and the height H of the third section 43 meet the parameter requirements of the aforementioned embodiments, achieving the objective of reducing the exposed size of the sealing piece 3. In an embodiment of this application, the second section 42 and the third section 43 are symmetrically arranged at two ends of the first section 41, either as rounded corner structures bent outward or as rounded corner structures recessed inward. In other embodiments, the second section 42 and the third section 43 may alternatively be one as a rounded corner structure bent outward and the other as a rounded corner structure recessed inward, to meet actual design requirements.

Referring to FIG. 11, the second section 42 and/or the third section 43 is provided with a depression 44, such that the second section 42 and/or the third section 43 includes a first subsection 45 and a second subsection 46. The first subsection 45 is located between the first section 41 and the second subsection 46, the second subsection 46 includes at least one section, an endpoint connecting the first subsection 45 and the first section 41 is M, an endpoint connecting the second subsection 46 and the side edge of the sealing piece 3 is N, the connection endpoint M and the connection endpoint N form a line segment MN, and an included angle between the first section 41 and the line segment MN is greater than or equal to 90°.

In an embodiment of this application, the first subsection 45 and the second subsection 46 are respectively two adjacent sides of the depression 44, and the included angle between the first subsection 45 and the second subsection 46 is less than 180°, such that the second section 42 and the third section 43 have a stepped surface structure recessed toward the side edge 6 of the tab 12, which can further reduce the impact caused by the outward-extending deformation of the sealing piece 3 and reduce the exposed size of the sealing piece 3. In other embodiments, as shown in FIG. 13, the second subsection 46 includes at least two sections, and the included angle between adjacent sections is greater than or equal to 90°. This multi-section structure can cause the deformation amount of the sealing piece 3 extending outward to be mainly within the plane range of the electrochemical apparatus 100, reducing the warping amount of the sealing piece 3 in the thickness direction of the electrochemical apparatus 100, thus helping reduce the loss of energy density. In a possible embodiment of this application, the second subsection 46 includes n sections, the n-th section is connected to the side edge of the sealing piece 3, the distances from the intersections between the (n−1)th section close to the first subsection 45 and the n-th section to the side edge of the tab 12 do not exceed 2.5 mm. This multi-section arrangement allows the top edge 4 of the sealing piece 3 to fit better, improving the sealing performance of the electrochemical apparatus.

Further, referring to FIG. 12, a groove 47 is further provided between the first subsection 45 and the second subsection 46, the structure of the groove 47 may be arc-shaped, rectangular, polygonal, or the like, for absorbing the deformation of the sealing piece 3, and under the action of the groove 47, when the sealing piece 3 is hot pressed to deform, the first subsection 45 and the second subsection 46 may approach each other, reducing the risk caused by the outward-extending deformation of the top edge 4.

Still referring to FIGS. 7 and 8, an embodiment of this application also provides an electronic device 200. The electronic device 200 includes a housing 201, an electronic component connection line 203, and the electrochemical apparatus 100 as described in the above embodiments, where the electronic component connection line 203 and the electrochemical apparatus 100 are disposed in the housing 201, and the electronic component connection line 203 is electrically connected to the battery cell 1 in the electrochemical apparatus 100 via a circuit board 7. Specifically, the housing 201 is provided with an accommodating cavity 202, the electrochemical apparatus 100 is mounted in the accommodating cavity 202, and the top edge 4 of the sealing piece 3 of the electrochemical apparatus 100 does not exceed the accommodating cavity 202. This arrangement of the second section 42 and the third section 43 alleviates the problem caused by the outward-extending warping of the top edge 4 of the sealing piece 3 after hot pressing, thereby preventing interference problems when the electrochemical apparatus 100 is placed in the accommodating cavity 202, which can reduce the size of the accommodating cavity 202 to some extent, contributing to the miniaturization of the electronic device 200.

According to the electrochemical apparatus 100 and the electronic device 200 of this application, the height difference between the second section 42 and the first section 41 and the height difference between the third section 43 and the first section 41 are formed, such that after hot pressing and sealing, the second section 42 and the third section 43 do not exceed the first section 41. The height difference between the second section 42 and the first section 41 and the height difference between the third section 43 and the first section 41 can offset the deformation amount of the sealing piece 3 extending outward, thereby alleviating the problem of two sides of the top end of the sealing piece 3 warping, and preventing an increase in the exposed length of the sealing piece 3. After the tab 12 is bent, because the sealing piece 3 does not have a warping problem, the sealing piece has a reduced exposed length, and does not protrude relative to the battery cell in the thickness direction of the battery cell, thereby reducing the overall length and thickness of the electrochemical apparatus 100, and increasing the energy density of the electrochemical apparatus 100.

An embodiment of this application provides a manufacturing method for electrochemical apparatus, used for manufacturing the electrochemical apparatus 100 in the above embodiments. The manufacturing method for electrochemical apparatus includes the following steps:
die-cutting the top edge 4 of the sealing piece 3, such that the top edge 4 of the sealing piece 3 forms the first section 41, the second section 42, and the third section 43, where the second section 42 and the third section 43 are respectively located on two sides of the first section 41, along the width direction of the tab 12, the length of the first section 41 is A, the length of the bottom edge 5 is B, and the width of the tab 12 is C, satisfying B>A≥C; and along the extension direction of the tab 12, the distance from any point on the second section 42 and the third section 43 to the bottom edge 5 is less than a distance between the first section 41 and the bottom edge 5;
preparing the tab 12, and adhering the sealing piece 3 to the tab 12;
welding the tab 12 to the electrode plate 11, winding or stacking the electrode plate to form the battery cell 1, and placing the battery cell 1 into the packaging bag 2, where the tab 12 protrudes from the sealing edge 21 of the packaging bag 2, the packaging bag 2 covers part of the sealing piece 3, the top edge 4 of the sealing piece 3 is located outside the packaging bag, and the bottom edge 5 is located inside the packaging bag; and
hot pressing and sealing the packaging bag 2, where the sealing piece 3 is sealingly connected between the packaging bag 2 and the tab 12.

In an embodiment of this application, the material of the sealing piece 3 includes polypropylene. The thickness of the sealing piece 3 is 30 μm-80 μm, and the melting temperature is 123±5° C.-158±10° C. The sealing piece 3 within this thickness range can provide effective sealing without excessively increasing the thickness of the sealing region of the packaging bag 2, leaving enough space for the subsequent installation of the circuit board.

In the hot pressing and sealing step, the hot pressing pressure is 120±50 Kgf, and the hot pressing temperature is 190±5° C. The extension amount of the sealing piece 3 may be slightly adjusted based on the hot pressing parameters. Higher temperature, greater pressure, or longer hot pressing time causes a greater extension amount. Limiting the hot pressing parameters in this application can minimize the extension amount of the sealing piece while the sealing piece is sealingly connected between the tab and the packaging bag, and also minimize the impact of the extension amount on the exposed length of the sealing piece.

In an embodiment of this application, after hot pressing and sealing, the difference between the length B of the bottom edge 5 of the sealing piece 3 and the length A of the first section 41 is 0<B−A≤8 mm, such that the length A of the first section 41 is less than the length B of the bottom edge 5, and the second section 42 and the third section 43 can be formed on two sides of the first section 41. The height H of the second section 42 and the third section 43 meets 0.05 mm≤H≤0.5 mm, ensuring that the second section 42 and the third section 43 do not exceed the first section 41, which can reduce the impact caused by the outward-extending deformation of the sealing piece, thereby achieving the objective of reducing the exposed size of the sealing piece, and alleviating interference problems during subsequent assembly. The shoulder width W of the top edge of the sealing piece 3 meets 0.3 mm≤W≤1.1 mm, helping maintain the covering effect of the sealing piece 3 on the tab 12, thus ensuring the sealing performance between the tab 12 and the packaging bag 2. The shoulder width X of the bottom edge 5 of the sealing piece 3 meets 0.3 mm≤X≤4.5 mm, such that an end of the bottom edge 5 of the sealing piece 3 exceeds an end of the first section 41, increasing the contact area of the sealing piece 3 in the packaging bag 2, which helps ensure the sealing effect between the tab 12 and the packaging bag 2. The height Y of the sealing piece 3 meets 3.5 mm≤Y≤12.5 mm, to maintain the sealing effect between the tab 12 and the packaging bag 2 while reasonably planning the height dimensions of the sealing piece 3, alleviating the problem of the increase in the overall size of the electrochemical apparatus 100 caused by excessive exposure of the sealing piece 3.

Further, in an embodiment of this application, 1.8 mm≤B−A≤8 mm, such that the two ends of the first section 41 can form distinct second section 42 and third section 43, reducing the exposed size of the sealing piece 3, alleviating interference problems during assembly, and reducing the loss of energy density of the electrochemical apparatus. Further, in an embodiment, the difference B−A between the length B of the bottom edge 5 of the sealing piece 3 and the length A of the first section 41 is preferably 3 mm≤B−A≤7 mm, which helps further reduce the exposed size of the sealing piece 3. It should be noted that the parameter range of the difference B−A between the length B of the bottom edge 5 and the length A of the first section 41 is the parameter range after hot sealing of the sealing piece 3, to ensure that the top edge 4 of the sealing piece 3 has no part extending outward and deforming, achieving the objective of reducing the exposed size of the sealing piece 3.

Further, in an embodiment, the height H of the second section 42 or the third section 43 is preferably 0.15 mm≤H≤0.3 mm. This parameter range is also the height parameter range of the second section 42 and/or the third section 43 of the sealing piece 3 after hot melting, so as to further reduce the exposed size of the sealing piece 3, meeting subsequent assembly requirements.

In a possible embodiment of this application, the second section 42 and/or the third section 43 is provided with a depression 44, such that the second section 42 and/or the third section 43 includes a first subsection 45 and a second subsection 46. The first subsection 45 is located between the first section 41 and the second subsection 46, the second subsection 46 includes at least one section, an endpoint connecting the first subsection 45 and the first section 41 is M₁, an endpoint connecting the second subsection 46 and the side edge of the sealing piece 3 is N₁, the connection endpoint M₁ and the connection endpoint N₁ form a line segment M₁N₁, and an included angle between the first section 41 and the line segment M₁N₁ is greater than or equal to 90°.

In a possible embodiment of this application, the second subsection 46 includes at least two sections, and the included angle between adjacent sections is greater than or equal to 90°. This multi-section structure can cause the deformation amount of the sealing piece 3 extending outward to be mainly within the plane range of the electrochemical apparatus 100, reducing the warping amount of the sealing piece 3 in the thickness direction of the electrochemical apparatus 100, thus helping to reduce the loss of energy density.

Further, the second subsection 46 includes the n sections, and the n-th section is connected to the side edge of the sealing piece 3. Before the hot pressing and sealing process, when the second subsection 46 is cut into n sections, the distance from the intersection between the n-th section to the side edge of the tab 12 does not exceed 2 mm, so as to provide a certain deformation space for the sealing piece. After the hot pressing and sealing process, the distances from the intersections between the (n−1)th section close to the first subsection 45 and the n-th section to the side edge of the tab 12 do not exceed 2.5 mm. This multi-section arrangement allows the top edge 4 of the sealing piece 3 to fit better, improving the sealing performance of the electrochemical apparatus.

Additionally, the second section 42 includes a first subsection 45 and a second subsection 46, where the second subsection 46 includes n sections, and the n-th section of the second subsection 46 is formed by cutting the sealing piece before the step of bonding the sealing piece and the tab. The first subsection 45 and the (n−1)th section of the second subsection can increase the extension amount of the partial regions of the sealing piece 3 on two sides of the tab 12 along the extension direction of the tab 12 by adjusting the hot pressing pressure and hot pressing temperature. This facilitates tight fitting of the sealing piece 12, reducing the electrolyte leakage rate.

In an embodiment of this application, after the cutting of the sealing piece and before the hot pressing and sealing step, the difference between the length B₁ of the bottom edge of the sealing piece and the length A₁ of the first section is 0.2<B₁−A₁≤8.3 mm. Further, the height H₁ of the second section and the third section meets 0.15 mm≤H₁≤0.7 mm, and the shoulder width W₁ of the top edge of the sealing piece meets 0.2 mm≤W₁≤1.3 mm. The shoulder width X of the bottom edge of the sealing piece meets 0.3 mm≤X≤4.5 mm. The height Y of the sealing piece meets 3.5 mm≤Y≤12.5 mm. Before hot pressing and sealing, a cutting size parameter of part of the sealing piece is greater than that of part of the sealing piece after hot pressing and sealing, to reserve a certain deformation margin and tolerance range for the subsequent hot melting deformation of the sealing piece during the cutting stage, allowing the deformation amount of the sealing piece to be within a controllable range, thereby avoiding problems such as the sealing piece extending outward or warping after hot sealing.

The foregoing embodiments are merely intended to describe the technical solutions of this application, but not intended to constitute any limitation. Although this application is described in detail with reference to the foregoing preferred embodiments, persons of ordinary skill in the art should understand that modifications or equivalent replacements can be made to the technical solutions of this application, without departing from the spirit and scope of the technical solutions of this application.

What is claimed is:

1. An electrochemical apparatus, comprising:
a battery cell comprising an electrode plate and a tab connected to the electrode plate;
a packaging bag, wherein the battery cell is disposed in the packaging bag, the tab extends away from the electrode plate and protrudes out from a sealing edge of the packaging bag in a first direction; and
a sealing piece disposed on two sides of the tab, wherein the packaging bag covers a part of the sealing piece, the sealing piece comprises a top edge and a bottom edge opposite to each other in the first direction, the top edge is located outside the packaging bag, and the bottom edge is located inside the packaging bag;
wherein the top edge comprises a first section, a second section, and a third section; the first section is located between the second section and the third section along a width direction of the tab; along the width direction of the tab, a length of the first section is A, a length of the bottom edge is B, and a width of the tab is C, and B>A≥C, 1.8 mm≤B−A≤8 mm; wherein along the width direction of the tab, the first section completely overlaps the tab;
along the first direction, a distance between any point on the second section and the bottom edge is less than a distance between any point on the first section and the bottom edge;
along the first direction, a distance between any point on the third section and the bottom edge is less than the distance between any point on the first section and the bottom edge; and
along the first direction, a distance between two ends of the second section or a distance between two ends of the third section is a height H of the second section or the third section, wherein 0.05 mm≤H≤0.5 mm.

2. The electrochemical apparatus according to claim 1, wherein 3 mm≤B−A≤7 mm.

3. The electrochemical apparatus according to claim 1, wherein 0.15 mm≤H≤0.3 mm.

4. The electrochemical apparatus according to claim 1, wherein
along the width direction of the tab, a distance between the second section and the tab or a distance between the third section and the tab is W, wherein 0.3 mm≤W≤1.1 mm.

5. The electrochemical apparatus according to claim 1, wherein
along the width direction of the tab, a distance between a side edge of the sealing piece and a corresponding side edge of the tab is X, wherein 0.3 mm≤X≤4.5 mm.

6. The electrochemical apparatus according to claim 5, wherein
along the first direction, a distance between the first section and the bottom edge is a height Y of the sealing piece, wherein 3.5 mm≤Y≤12.5 mm.

7. The electrochemical apparatus according to claim 1, wherein
the second section is obliquely connected between an end of the first section and a side edge of the sealing piece, and the third section is obliquely connected between another end of the first section and another side edge of the sealing piece.

8. The electrochemical apparatus according to claim 1, wherein
the second section is an arc section connected between an end of the first section and a side edge of the sealing piece, and the second section is recessed toward a side edge of the tab or the second section is bent toward an outer side of the sealing piece.

9. The electrochemical apparatus according to claim 8, wherein
the third section is an arc section connected between another end of the first section and another side edge of the sealing piece, and the third section is recessed toward the side edge of the tab or the third section protrudes toward the outer side of the sealing piece.

10. The electrochemical apparatus according to claim 1, wherein
the second section and/or the third section comprises a first subsection and a second subsection, wherein the first subsection is located between the first section and the second subsection, the second subsection comprises at least one section, an endpoint connecting the first subsection and the first section is M, an endpoint connecting the second subsection and the side edge of the sealing piece is N, the connection endpoint M and the connection endpoint N form a line segment MN, and an included angle between the first section and the line segment MN is greater than or equal to 90°.

11. The electrochemical apparatus according to claim 10, wherein
the second subsection comprises at least two sections, and an included angle between adjacent sections in the at least two sections is greater than or equal to 90°.

12. The electrochemical apparatus according to claim 10, wherein the second subsection comprises n sections, an n-th section is connected to the side edge of the sealing piece, and distances from intersections between (n−1)th section close to the first subsection and the n-th section to the side edge of the tab do not exceed 2.5 mm.

13. The electrochemical apparatus according to claim 10, wherein
a groove is provided between the first subsection and the second subsection to absorb deformation of the sealing piece.

14. The electrochemical apparatus according to claim 1, wherein
along the first direction, a distance between an end of the second section away from the first section and the sealing edge of the packaging bag and a distance between an end of the third section away from the first section and the sealing edge of the packaging bag are both greater than or equal to 0.1 mm.

15. The electrochemical apparatus according to claim 1, wherein
the electrochemical apparatus further comprises a circuit board, wherein the circuit board is located on a side of the sealing piece and covers a part of the sealing piece exposed by the packaging bag, and an end of the tab protruding out from the packaging bag is bent towards the circuit board and connected to the circuit board.

16. The electrochemical apparatus according to claim 1, wherein
the packaging bag is rectangular, and along the first direction, vertical distances from any points on the sealing edge to the first section of the top edge are identical.

17. An electronic device, comprising a housing, an electronic component connection line, and the electrochemical apparatus according to claim 1, wherein the electronic component connection line and the electrochemical apparatus are disposed in the housing, and the electronic component connection line is electrically connected to the electrochemical apparatus;
the housing comprises an accommodating cavity, the electrochemical apparatus is mounted in the accommodating cavity, and the top edge of the sealing piece of the electrochemical apparatus does not exceed the accommodating cavity.

18. A method for manufacturing the electrochemical apparatus of claim 1, method comprising:
die-cutting the top edge of the sealing piece, such that the top edge of the sealing piece forms the first section, the second section, and the third section, wherein the second section and the third section are respectively located on two sides of the first section, and along the width direction of the tab, the length of the first section is A, the length of the bottom edge is B, and the width of the tab is C, meeting B>A≥C; and along the first direction, the distance from any point on the second section and the third section to the bottom edge is less than a distance between the first section and the bottom edge;
adhering the sealing piece to the tab;
welding the tab to the electrode plate, and winding or stacking the electrode plate to form the battery cell;
placing the battery cell into the packaging bag, wherein the tab protrudes from the sealing edge of the packaging bag, the packaging bag covers part of the sealing piece, the top edge of the sealing piece is located outside the packaging bag, and the bottom edge of the sealing piece is located inside the packaging bag; and
hot pressing and sealing the packaging bag, wherein the sealing piece is sealingly connected between the packaging bag and the tab.

19. The method for manufacturing the electrochemical apparatus according to claim 18, wherein
in the step of hot pressing and sealing the packaging bag, a hot pressing pressure is 120±50 Kgf, and a hot pressing temperature is 190±5° C.

20. The method for manufacturing the electrochemical apparatus according to claim 18, wherein
after the die-cutting the top edge of the sealing piece, the distance between two ends of the second section or the third section is a height H₁ of the second section or the third section, wherein 0.15 mm≤H₁≤0.7 mm; and
after the step of hot pressing and sealing the packaging bag, the height of the second section or the third section is H, wherein 0.05 mm≤H≤0.5 mm;
after the die-cutting the top edge of the sealing piece, a length of the bottom edge of the sealing piece is B₁, and a length of the first section is A₁, meeting 0.2<B₁−A₁≤8.3 mm; and
after the step of hot pressing and sealing the packaging bag, 0<B−A≤8 mm.
